(19) United States
(12) Patent Application Publication
(10) Pub. No.: US 2013/0026015 A1
(43) Pub. Date: Jan. 31, 2013

(54) VENT STRUCTURE FOR A HOUSING OF AN ELECTRICAL APPLIANCE

(71) Applicants: Chao Chen, Shenzhen (CN); Xiaoning Zhang, Shenzhen (CN); Furong Zhang, Shanghai (CN); Yiqing Chen, Shanghai (CN)

(72) Inventors: Chao Chen, Shenzhen (CN); Xiaoning Zhang, Shenzhen (CN); Furong Zhang, Shanghai (CN); Yiqing Chen, Shanghai (CN)

(73) Assignee: Tyco Electronics (Shenzhen) Co. Ltd., Guangdong (CN)

(21) Appl. No.: 13/583,421

(22) PCT Filed: Mar. 8, 2011
(86) PCT No.: PCT/IB2011/050969

§ 371 Date: Oct. 11, 2012

(30) Foreign Application Priority Data
Mar. 10, 2010 (CN) 201020130522.0

(51) Int. Cl. H01H 9/02

(52) U.S. Cl. 200/293

(57) ABSTRACT

The present invention relates to the field of electric appliance such as AC/DC relay, AC/DC contactor and AC/DC low-voltage apparatus, and in particular, to a vent structure formed on the housing of an electric appliance. In one preferred embodiment, the present invention provides a vent structure for the housing of an electric appliance, the vent structure is defined by a clearance between a first wall and a second wall formed on the housing, the clearance is located between a first surface of the first wall and a second surface of the second wall, wherein the first wall and the second wall are not in the same plane. According to the present invention, a specific die is adopted in molding such housing. By the engagement between the male and female die inserts in the die, the vent structure in the housing of an electric appliance has a staggered and drop structure.

### CROSS-REFERENCE TO RELATED APPLICATION

This application claims the benefit of Chinese Patent Application No. 201020130522.0 filed on Mar. 10, 2010 in the State Intellectual Property Office of China, the disclosure of which is incorporated herein by reference.

### BACKGROUND OF THE INVENTION

1. Field of the Invention

The present invention relates to a field of electric appliance such as AC/DC relay, AC/DC contactor and AC/DC low-voltage apparatus, and in particular, to a vent structure formed on the housing of an electric appliance.

2. Description of the Related Art

AC/DC relay, AC/DC contactor and AC/DC low-voltage apparatus are automatic switching electric appliances for achieving the frequent switch on/off functions of the DC main circuit. The devices controlled by these electric appliances include electronic/electrical equipments, engineering machinery, household appliances, electrical load equipments, industrial plant, converter, and so on. At present, AC/DC relay, AC/DC contactor and AC/DC low-voltage apparatus are widely adopted in the industries like electronic/electrical equipments, engineering machinery, household appliances, electrical load equipments, industrial plant, converter, and so on.

Nowadays, there are two types of AC/DC relay, AC/DC contactor and AC/DC low-voltage apparatus, sealed and unsealed. The unsealed one usually has a vent feature. However, the conventional vent feature is disadvantageous in manufacturing yield of the die assembly, stability of mass production of the die, quality of the assembly, assurance of the minimal vent size to prevent intrusion of ants, etc. FIGS. 1a-1f show a conventional vent structure feature, FIG. 2 shows a female die insert of a die for formation of the conventional vent structure, and FIG. 3 is a schematic view showing the engagement between male and female die inserts in the die.

Specifically, the conventional vent structure feature has the follow disadvantages and/or defects:

Firstly, the manufacturing yield of the vent of the products (electric appliance housing) is poor and the reliability of the finished product is not satisfactory, which results in high manufacture cost.

Secondly, in the manufacturing process, the actual sizes of the products usually fail to meet the size as required to ensure the functionality of the product, e.g., size of the vent may not achieve minimal size of 0.14 mm to prevent intrusion of ants.

Thirdly, the vents may encounter serious defects, such as burrs at the peripheral of the vent, and burning of the vent due to hot gas passing therethrough.

Fourthly, it is difficulty to fill up the vent during the molding process because of the small size and sharp shape of the vent.

Fifthly, die inserts have short service life and are frequently replaced, thus, maintenance times of die inserts are increased, which cause manufacturing inefficiency. Sixthly, since size consistency of the vents is poor, the competitiveness of the finished product is degraded.

That is to say, with the conventional vent structure feature, the vent structure often fails to satisfy the design requirements of the product, as a result, the vent has serious defects, poor stability, and relatively complicated manufacturing process, and the resultant vent may not satisfy the design and functionality requirements during the molding process.

With the development of the technology, there are higher functional and technical requirements for the electrical devices such as relay, higher quality requirements for the products, and strict requirements for low manufacturing cost. Therefore, it is desirable in the art to provide a vent structure which may overcome or alleviate at least one aspect of the above-mentioned problems.

### SUMMARY OF THE INVENTION

It is an object of the present invention to provide a vent structure for the housing of an electric appliance to overcome or alleviate one or more of the above mentioned drawbacks or disadvantages in the art.

According to an aspect of the present invention, there is provided a vent structure for the housing of an electric appliance, the vent structure defined by a clearance between a first wall and a second wall formed on the housing, the clearance is located between a first surface of the first wall and a second surface of the second wall, wherein the first wall and the second wall are not in a same plane.

In one preferred embodiment of the present invention, the second wall and the first wall are paralleled with each other, an upper surface of the second wall is higher than an upper surface of the first wall, and, a lower surface of the second wall is higher than a lower surface of the first wall.

Preferably, the upper surface of the second wall is lower than the top surface of the housing of an electric appliance.

In another preferred embodiment of the present invention, the upper surface of the second wall and a top surface of the housing of an electric appliance are in a same plane.

In a specific embodiment the second wall is parallel with the top surface of the housing of an electric appliance.

Particularly, the clearance has a bar-shaped cross section. Preferably, the width of the clearance equals to or is less than 0.13 mm.

In one preferred embodiment of the present invention, the entire configuration of the vent structure has a cross section of circular shape. In other preferred embodiments of the present invention, the entire configuration of the vent structure may have any shape from oval, rectangle to square, or any other regular or irregular shapes.

As apparent from the above, the present invention has at least the following advantages:

The present invention provides a vent structure applied on the housing of an electric appliance. A specific die is adopted in the molding of such housing. Through engagement between the male and female die inserts in the die, the vent structure in the housing of an electric appliance has a staggered and drop structure. The vent structure on the housing of an electric appliance according to the present invention at least has one of the following benefits and advantages in molding process and final configuration of the housing:

1. The housing is made by plastic material, the cost is low, and the manufacturing process is simplified. Product design and die replacement are much easier and, the housing can be manufactured in mass production;

2. The reliability of CASE products such as relay has been greatly improved during mass production;

3. The manufacturing yield of the female die insert and the reliability of the mass production of the die has been greatly improved;

4. The female die insert has more service life due to its improved strength, less maintenance cost due to improved reliability of the die, less manufacture inefficiency, and lower cost.

5. The engaging surface of the male die insert which abuts against that of the female die insert during molding can be processed by grinding machine so that manufacturing precision of the male die insert is improved;

6. Serious defects such as burr, burning of the vent by hot gas passing therethrough, difficulty in molding of the vent structure, etc., may be effectively reduced, so as to ensure quality of the vent structure in the housing of an electric appliance;

7. The vent structure according to the present invention not only exhibits a satisfactory ventilation performance, but also achieves a consistent size as required which ensures the functionality of the product, e.g., size of the vent may be less than 0.13 mm or more so as to prevent intrusion of ants.

The housing of an electric appliance with above-mentioned vent structure according to the present invention may be applied not only on the housing of an electric appliance like AC/DC relay, AC/DC contactor, AC/DC low-voltage apparatus, etc., but also on the housings of like products.

### BRIEF DESCRIPTION OF THE DRAWINGS

These and/or other objectives, features and advantages of the invention will become apparent and more readily appreciated from the following description of the embodiments, taken in conjunction with the accompanying drawings of which:

FIG. 1 is a structural schematic view of a housing of an electric appliance having a conventional vent structure feature in the prior art;

FIG. 1A is a partial enlarged view of the vent structure feature of the housing of an electric appliance;

FIG. 1B is a cross-sectional view along a B-B line in FIG. 1A;

FIG. 1C is a cross-sectional view along a C-C line in FIG. 1A;

FIG. 2 is a structural schematic view of a female die insert in a die with the conventional vent structure feature in the prior art;

FIG. 3 is a schematic view showing engagement between male and female die inserts with the conventional vent structure feature in the prior art;

FIG. 4 is a structural schematic view of a housing of an electric appliance according to one preferred embodiment of the present invention;

FIG. 4A is a side view of the housing of an electric appliance shown in FIG. 4;

FIG. 4B is a cross-sectional view along an A-A line in FIG. 4A;

FIG. 4C is a cross-sectional view along a B-B line in FIG. 4A;

FIG. 4D is a partial enlarged view of FIG. 4C showing the vent structure feature of the housing of an electric appliance according to one preferred embodiment of the present invention;

FIG. 5 is a structural schematic view of a female die insert in a die with the conventional vent structure feature according to one preferred embodiment of the present invention;

FIG. 6 is a schematic view showing engagement between male and female die inserts with the conventional vent structure feature according to one preferred embodiment of the present invention;

FIG. 6A is a side view of the die for the housing of an electric appliance shown in FIG. 6;

FIG. 6B is another side view of the die for the housing of an electric appliance shown in FIG. 6;

FIG. 6C is a partial enlarged view of FIG. 6B showing a state in which the vent structure is being molded by the male and female die inserts according to above preferred embodiment of the present invention.

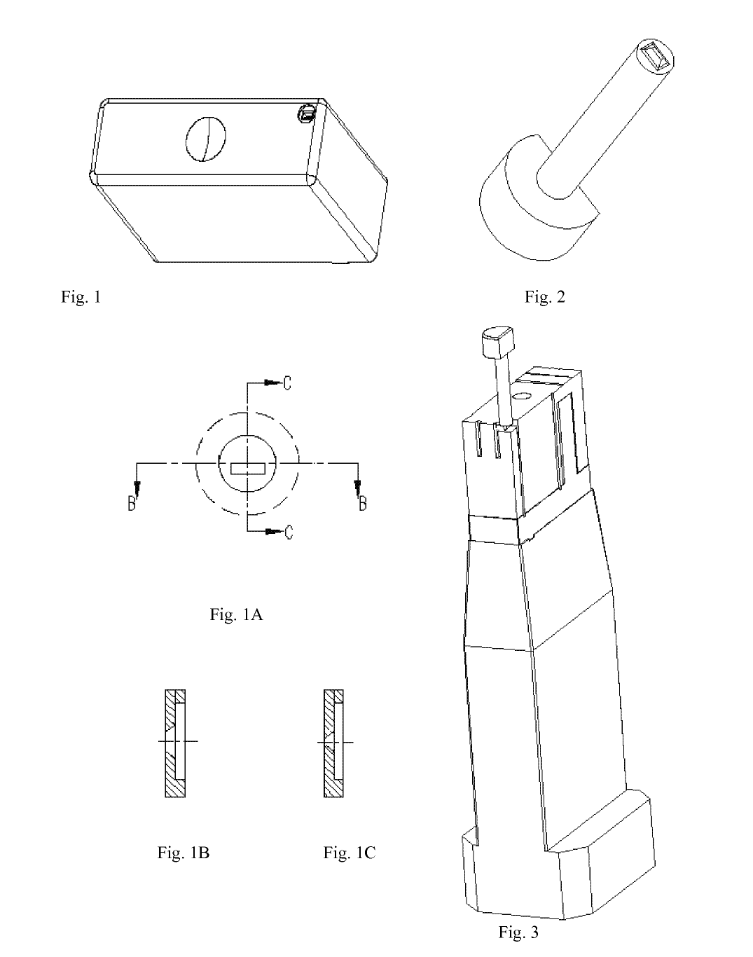

### DETAILED DESCRIPTION OF PREFERRED EMBODIMENTS OF THE INVENTION

Exemplary embodiments of the present disclosure will be described hereinafter in detail with reference to the attached drawings. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

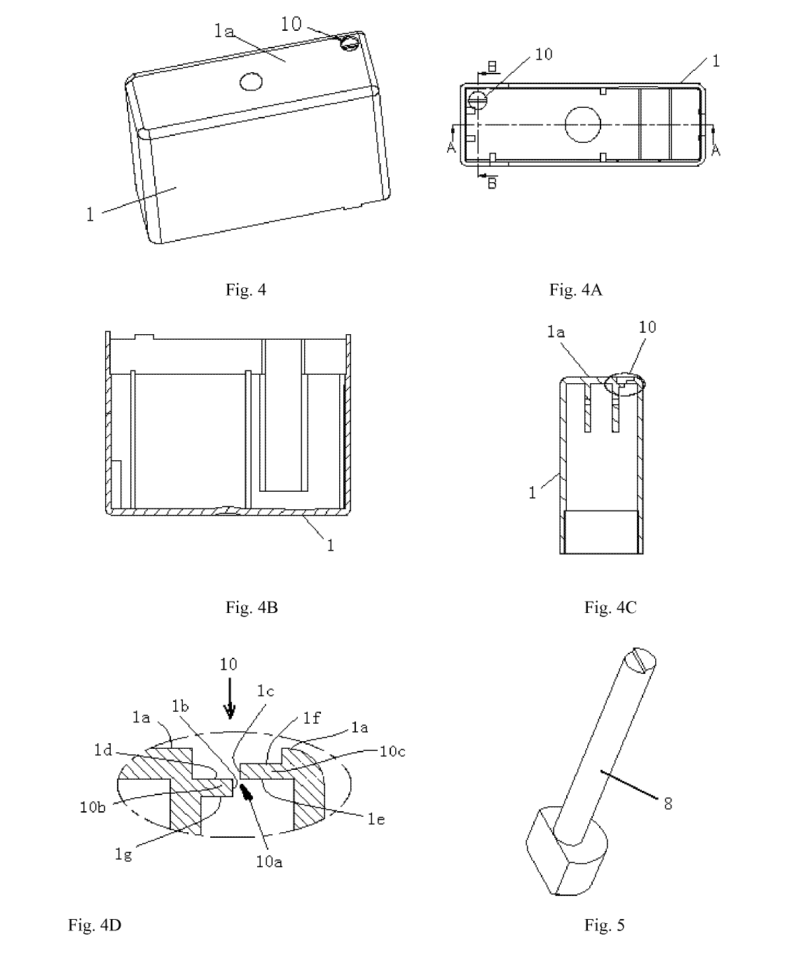

Please refer to FIGS. 4-11, the present invention provides a vent structure applied on the housing of an electric appliance, e.g., AC/DC relay, AC/DC contactor, AC/DC low-voltage apparatus, etc. Also, the present invention illustrates a die for such vent structure. The die comprises a male die insert and a female die insert with specific vent forming feature.

Specifically, as shown in FIG. 4 and FIGS. 4A-4D, the present invention provides a housing of an electric appliance 1 formed with a vent structure 10 thereon. According to one preferred embodiment of the present invention, as shown in FIG. 4 and FIGS. 4A-4C, the vent structure 10 is preferably formed proximate to a corner of the housing of an electric appliance 1, adapted for communicating the air inside the housing of an electric appliance 1 with the outside so as to achieve a ventilation function.

According to one preferred embodiment of the present invention, as shown in FIG.

4A, the appearance (entire configuration) of the vent structure 10 preferably has a circular shape. Obviously, in other preferred embodiments of the present invention, in accordance with actual design requirements, the entire configuration of the vent structure 10 may have a shape selected from oval shape, rectangle shape, square shape, or any other regular or irregular shapes. In fact, the entire configuration of the vent structure 10 is determined by the corresponding configuration of the female die insert (e.g., as shown in FIG. 5) in the die. According to the present invention, as shown in FIG. 4D, the vent structure 10 is defined by a clearance 10a between a first wall 10b and a second wall 10c formed on the housing 1, the clearance 10a is located between a first surface 1b of the first wall 10b and a second surface 1c of the second wall 10c, and, the first wall 10b and the second wall 10c are not in a same plane. That is to say, according to the present invention, there is a difference in height between the first wall 10b and the second wall 10c in the vent structure 10. For example, in the preferred embodiment shown in FIG. 4D, an upper surface 1d of the first wall 10b and the lower surface 1e of the second wall 10c are in the same plane, so that, there is a difference in height between the first wall 10b and the second wall 10c. According to one preferred embodiment of the present invention, the second wall 10c and the first wall 10b are parallel with each other, an upper surface 1f of the second wall 10c is higher than an upper surface 1d of the first wall 10b, and, a lower surface 1e of the second wall 10c is higher than a lower surface 1g of the first wall 10b. Meanwhile, the upper surface 1f of the second wall 10c is lower than the top surface 1a of the housing of an electric appliance 1. Further, in this preferred embodiment, the first surface 1b of the first wall 10b and the second surface 1c of the second wall 10c are parallel with each other and are approximately perpendicular to the first wall 10b and the second wall 10c.

Alternatively, in another preferred embodiment of the present invention, the upper surface if of the second wall 10c and the top surface 1a of the housing of an electric appliance 1 may be in a same plane.

Specifically, as shown in FIG. 4A, the clearance 10a has across section of a bar. According to the present invention, the width of the clearance 10a may be designed to be equal to or less than 0.13 mm. The clearance 10a with such design size not only has the functions of ventilation and but also satisfies the size requirements of the vent for preventing the intrusion of foreign matters (for example, ants). Apparently, in other preferred embodiments, the size of the above-mentioned clearance may be designed in accordance with actual requirements. For example, the width of the clearance may be greater than 0.13 mm.

That is to say, the housing of an electric appliance according to the present invention adopts a vent feature of staggered and drop structure. Accordingly, size of the vent may be controlled in accordance with product demands, also, instances such as burr at the vent structure burning of the vent by gas passing therethrough, difficulty in molding of the vent structure, etc., may be effectively reduced, so as to ensure quality of the vent structure.

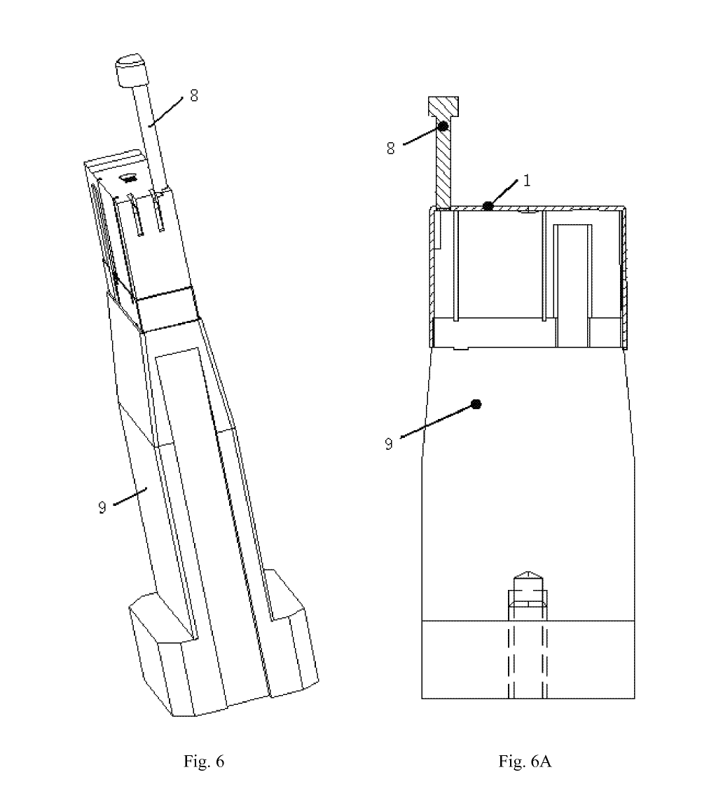

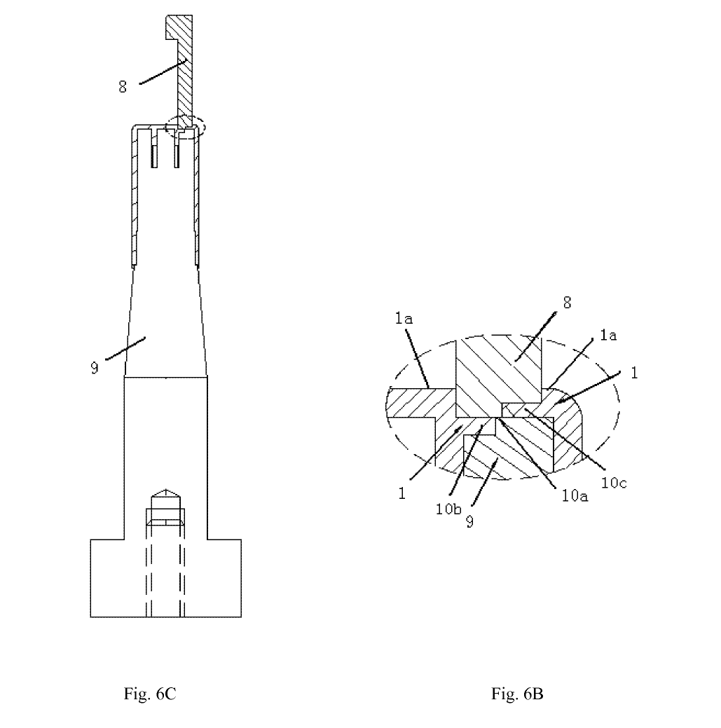

Referring to FIG. 5, FIG. 6 and FIGS. 6A-6C, a die including male/female die inserts 8, 9 for the housing of an electric appliance (particularly showing the structural features relating to the vent structure) according to one preferred embodiment of the present invention is illustrated.

As shown in FIG. 5, first, in an example that the vent structure takes a hollow circular shape, a shoulder of the female die insert 8 is configured to have a notched round section with high precision. With the notched round section, the female die insert 8 is prevented from rotating during the molding process so as to eliminate differences in sizes between two ends of the vent along the length direction of the vent when the male die insert and the female die insert are brought into engagement with each other during the molding of the vent structure. Second, as shown in FIG. 6 and FIGS. 6A-6C, for the engagement between the male and female die inserts 8, 9, the male die insert 8 and the female die insert 9 can be processed to have a precision of about 0.002 mm by means of a grinding machine. Particularly, the evenness of the engagement surfaces of the male and female die inserts 8, 9 should be strictly controlled and actually determined. Further, high evenness of the engagement surfaces contribute to engagement with each other and separation of the male and female die inserts during the molding process. Here, it should be noted that, the female die insert 8 with excessive height may cause excess amount of contact when the male die insert and the female die insert engage with each other, which in turn causes damages to the die inserts. On the other hand, the female die insert 8 with insufficient height may cause burr around the finished vent. Therefore, in order to avoid the above-mentioned situations, actual sizes of the die inserts and their fittings should be determined when assembling the die inserts, so as to provide reference sizes of the inserts for adjusting the height of the die inserts. Finally, when the die inserts are machined and assembled, size of the male die insert 9 should be accurately controlled in accordance with its size as designed, then, size (actual height) of the female die insert 8 may be adjusted, so as to adjust the amount of contact where the male die insert and the female die insert engage with each other. By adopting the above-mentioned method, the thicknesses of the acquired male and female die inserts 8, 9 depend on that of the housing of an electric appliance. In the engagement of the male and female die inserts 8, 9 in a die, at least certain contact portion (i.e., the vent structure in the electrical appliance housing) between the male die insert 9 and female die insert 8. FIG. 6C shows a state in which the male and female die inserts 8, 9 are engaged with each other in a die.

The housing of an electric appliance with above-mentioned vent structure according to the present invention may be applied not only on the housing of electric appliances like AC/DC relay, AC/DC contactor, AC/DC low-voltage apparatus, etc., but also on the housings of similar products.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1-10. (canceled)

11. A vent structure for the housing of an electric appliance, wherein said vent structure is defined by a clearance between a first wall and a second wall formed on the housing, said clearance is located between a first surface of the first wall and a second surface of the second wall, wherein said first wall and said second wall are not in the same plane.

12. The vent structure according to claim 11, wherein said second wall and said first wall are parallel with each other, an upper surface of said second wall is higher than an upper surface of said first wall, and, a lower surface of said second wall is higher than a lower surface of said first wall.

13. The vent structure according to claim 12, wherein said upper surface of said second wall and a top surface of the housing of the electric appliance are in a same plane.

14. The vent structure according to claim 12, wherein said upper surface of said second wall is lower than said top surface of the housing of the electric appliance.

15. The vent structure according to claim 14, wherein said second wall is parallel with said top surface of the housing of the electric appliance.

16. The vent structure according to claim 11, wherein aid clearance has a bar-shaped cross section.

17. The vent structure according to claim 11, wherein the width of said clearance is equal to or less than 0.13 mm.

18. The vent structure according to claim 11, wherein the entire configuration of said vent structure has a circular shape.

19. The vent structure according to claim 11, wherein the entire configuration of said vent structure has an oval shape.

20. The vent structure according to claim 11, wherein the entire configuration of said vent structure has a square shape.
